(19) United States
(12) Patent Application Publication
(10) Pub. No.: US 2026/0366577 A1
(43) Pub. Date: Nov. 19, 2026

(54) SLIP CLUTCH ASSEMBLY WITH INTEGRATED MAGNET

(71) Applicant: STRATTEC POWER ACCESS LLC, Auburn Hills, MI (US)

(72) Inventor: Daniel A. Ney, Lake Orion, MI (US)

(21) Appl. No.: 19/675,060

(22) Filed: May 12, 2026

Related U.S. Application Data
(60) Provisional application No. 63/804,935, filed on May 13, 2025.
(60) Provisional application No. 63/894,087, filed on Oct. 6, 2025.

(51) Int. Cl. F16D 7/02; F16D 27/14

(52) U.S. Cl. CPC F16D 7/021; F16D 27/14

(57) ABSTRACT

A slip clutch assembly for use with a system component for a power actuator includes an input member configured to be rotationally driven by input torque from an input shaft, an output member configured to be rotationally driven by the input member until a threshold torque is reached, and a magnetic member coupled to the output member.

### CROSS-REFERENCE TO RELATED APPLICATIONS

This application claims priority to U.S. Provisional Application No. 63/804,935, filed May 13, 2025, and U.S. Provisional Application No. 63/894,087, filed Oct. 6, 2025, the entire contents of each of which are incorporated herein by reference.

### FIELD

This disclosure relates generally to slip clutches, including slip clutches used within motor vehicles.

### SUMMARY

In one aspect, the disclosure provides a slip clutch assembly for use with a system component for a power actuator. The slip clutch assembly includes an input member configured to be rotationally driven by input torque from an input shaft, an output member configured to be rotationally driven by the input member until a threshold torque is reached, and a magnetic member coupled to the output member.

In another aspect, the disclosure provides a slip clutch assembly for use with a system component for a power actuator. The slip clutch assembly includes an output member including an interior housing portion having a cavity defined therein and an exterior housing portion integrally formed with the interior housing portion. The slip clutch assembly further includes an input member disposed within the cavity of the interior housing portion and operably coupled to the output member for co-rotation, the input member configured to receive an input torque from an input shaft driven by a power actuator. The slip clutch assembly further includes an output region integrally formed with the interior housing portion, the output region configured to provide an output torque to an output shaft operably coupled to the system component. The slip clutch assembly further includes a magnetic member integrated with the exterior housing portion, the magnetic member configured to be detected by a sensor proximate the output member to determine a rotational position of the output member.

In another aspect, the disclosure provides a slip clutch assembly for use with a system component for a power actuator. The slip clutch assembly includes an output member including an interior housing portion having a cavity defined therein and an exterior housing portion integrally formed with the interior housing portion. The slip clutch assembly further includes an input member disposed within the cavity of the interior housing portion and operably coupled to the output member for co-rotation, the input member configured to receive an input torque from an input shaft driven by a power actuator. The slip clutch assembly further includes a sensor disposed proximate the output member, and a magnetic wheel coupled to the exterior housing portion. The magnetic wheel is configured to be detected by the sensor to determine a rotational position of the output member. The sensor is located between an output of the slip clutch assembly and a location of slip between the output member and the input member.

Other aspects of the disclosure will become apparent by consideration of the detailed description and accompanying drawings.

### BRIEF DESCRIPTION OF THE DRAWINGS

FIG. 1 is a perspective view of a slip clutch assembly according to one example.

FIG. 2 is a cross-sectional view of the slip clutch assembly of FIG. 1.

FIG. 3 is a front view of a portion of the slip clutch assembly of FIG. 1, adjacent a Hall effect sensor.

FIG. 4 is a perspective view of a slip clutch assembly according to another example.

FIG. 5 is a cross-sectional view of the slip clutch assembly of FIG. 4.

FIG. 6 is a side view of the slip clutch assembly of FIG. 4.

FIG. 7 is a perspective view of a slip clutch assembly according to another example.

FIG. 8 is a side, cross-sectional view of the slip clutch assembly of FIG. 7.

FIG. 9 is a cross-sectional view of the slip clutch assembly of FIG. 7, illustrating a first manufacturing process step.

FIG. 10 is a cross-sectional view of the slip clutch assembly of FIG. 7, illustrating a second manufacturing process step.

FIG. 11 is a perspective view of the slip clutch assembly of FIG. 7, after the first and second manufacturing steps.

FIG. 12 is a perspective, cross-sectional view of the slip clutch assembly of FIG. 7, further illustrating a magnetic member and magnetic wheel.

### DETAILED DESCRIPTION

Before any examples of the present disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways.

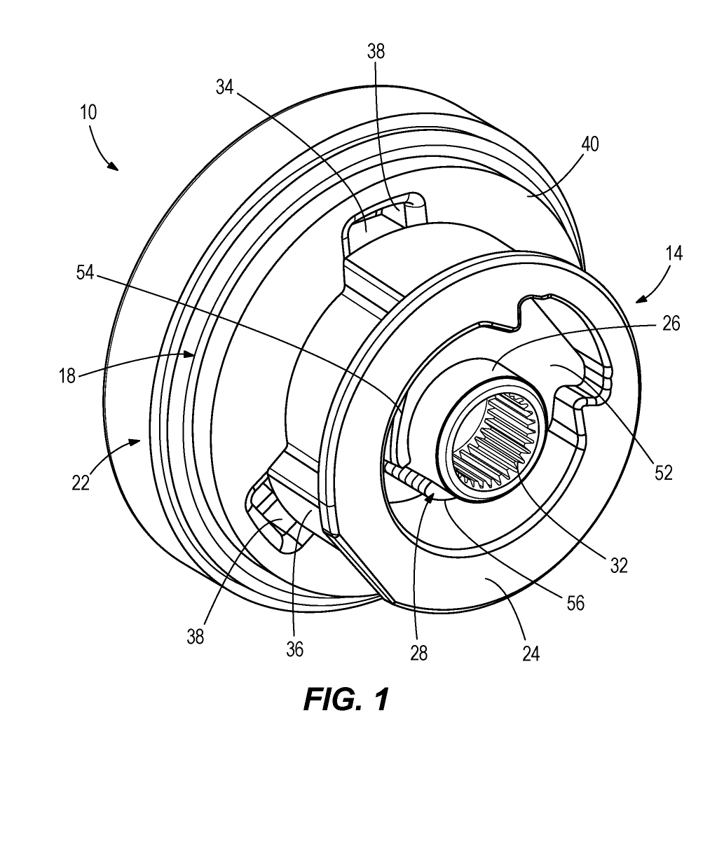

FIGS. 1-3 illustrate one example of a slip clutch assembly 10 for use within a motor vehicle or other structure. The slip clutch assembly 10 may be used, for example, to limit an amount of torque that is applied to a system component for a power actuator for a motor vehicle or other structure (e.g., for a power sliding door, a liftgate, a tail gate, or other vehicle component on a motor vehicle). The slip clutch assembly 10 may be positioned between a power actuator (not shown) and the system component to thereby limit the amount of torque applied to the system component from the power actuator.

The slip clutch assembly 10 generally includes a slip clutch 14, a magnet wheel housing 18 coupled to the slip clutch 14, and a magnetic member 22 coupled to the magnet wheel housing 18.

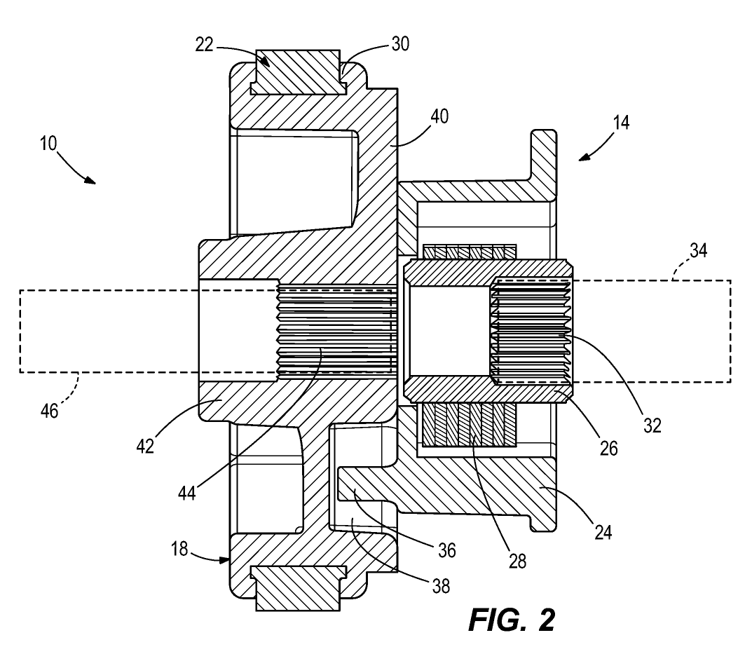

In the illustrated example, the slip clutch 14 includes an output member 24 and an input member 26 coupled to (and for example disposed at least partially within) the output member 24. As illustrated in FIGS. 1 and 2, the output member 24 includes a slip ring 28 (or rings) that frictionally engages the input member 26 (e.g., an exterior surface of the input member 26). During operation, the input member 26 drives rotation of the output member 24 until a torque threshold is reached, at which point the slip ring 28 slips relative to the input member 26.

With reference to FIG. 2, in the illustrated example the magnet wheel housing 18 includes an outer periphery 30 defining a channel or other area to receive the magnetic member 22. The magnetic member 22 is coupled (e.g., fixed) to the outer periphery 30. The magnetic member 22 may be a magnetic ring and/or have a circular shape, and/or comprise more than one magnetic element. Other examples may include other shapes and numbers of magnetic members.

With reference to FIGS. 1 and 2, in the illustrated example the input member 26 additionally includes a first spline configuration 32 formed therein. As seen in FIG. 2, an input shaft 34 (illustrated schematically) may be driven by the power actuator, and may be rotatably coupled to the input member 26 of the slip clutch 14. The first spline configuration 32 is sized and shaped to mate with a cooperating spline configuration (now shown) formed along the input shaft 34 for co-rotation. As such, the input member 26 is configured to receive an input torque from the input shaft 34 upon operation of the input shaft 34 by the power actuator.

With reference to FIGS. 1-3, in the illustrated example the output member 24 includes a plurality of projections 36 (e.g., extending axially). The projections 36 are sized and shaped to be received within recesses 38 defined within the magnet wheel housing 18, and serve as torque carrying features to couple the slip clutch 14 to the magnet wheel housing 18 for co-rotation. Other examples may include various other numbers and arrangements of torque carrying features. During use, the input shaft 34 is configured to rotate both the input member 26 and the output member 24, and to drive rotation of the magnet wheel housing 18 through the torque carrying features, until the torque threshold is reached.

With reference to FIGS. 1 and 2, in the illustrated example the magnet wheel housing 18 includes a body 40 and an output region 42 (FIG. 2) formed as part of the body 40. The output region 42 has a second spline configuration 44 formed therein and configured to mate with a cooperating spline configuration that is formed along an output shaft 46 (illustrated schematically in FIG. 2). The output shaft 46 may be operably coupled to the system component (e.g., motor vehicle component) so that the slip clutch assembly 10 may transfer torque from the power actuator through the slip clutch 14, through the magnet wheel housing 18, and to the system component.

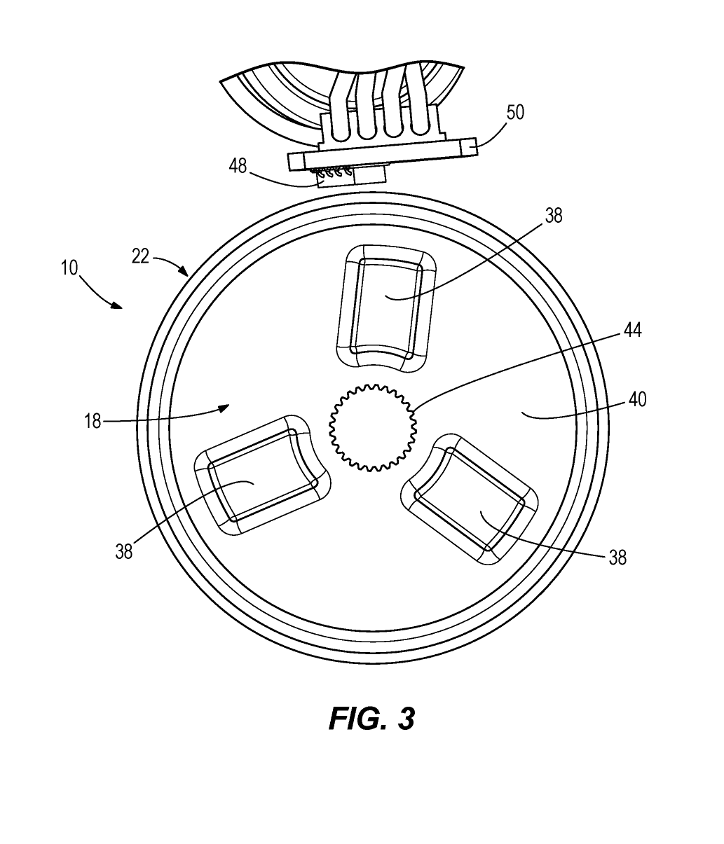

With reference to FIG. 3, the slip clutch assembly 10 further includes a sensor 48 located proximate the magnet wheel housing 18. The sensor 48 may be a Hall effect sensor or other sensor disposed on a printed circuit board (PCB) 50, and may electrically communicate with an electronic control unit (not shown). The magnetic member 22 is detectable by the sensor 48 to determine a rotational position of the magnet wheel housing 18.

With reference to FIG. 1, and as described above, the slip ring 28 (or rings 28) may be used to facilitate slip at a predetermined threshold of torque. As illustrated in FIG. 1, the slip ring 28 may include a base region 52 that is nestled into (e.g., keyed into) a recessed region of the output member 24 to transfer torque, and separate arms 54 and 56 that extend from the first region 52 and wrap at least partially around the input member 26, frictionally engaging an outer surface of the input member 26. Once the predetermined threshold of torque is reached, the frictional engagement may loosen, allowing the input member 26 to slip relative to the arms 54 and 56, and thus slip relative to the connected output member 24. Other examples may include various other shapes, sizes, and configurations of slip rings or other clutch mechanisms (e.g., having one or more arms, structures, and/or surfaces that frictionally engage the input member 26, along with at least one region, structure, or surface, such as the first region 52, that engages the output member 24 to thereby transfer torque between the slip ring 28 and the output member 24).

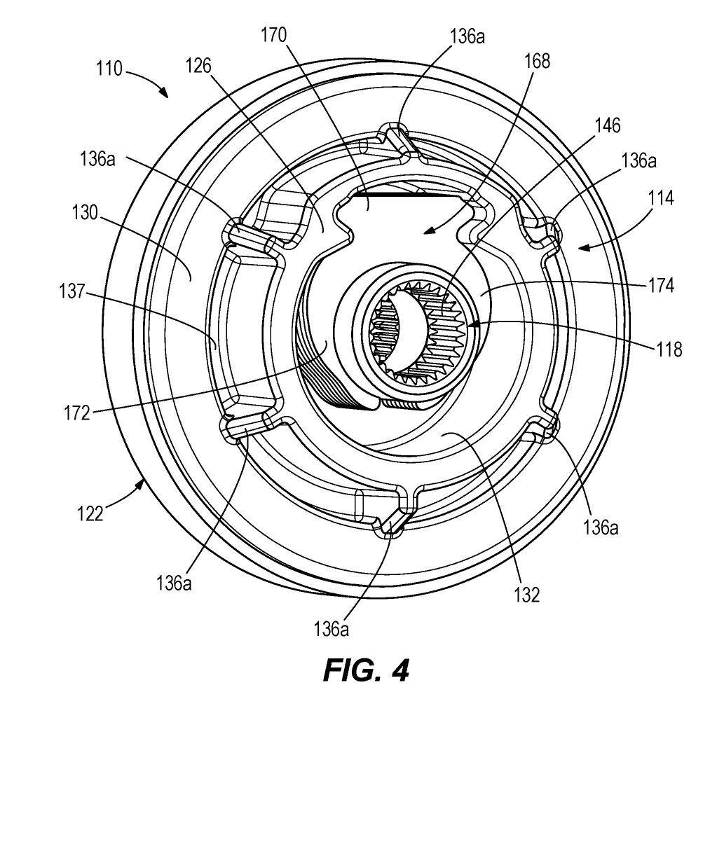

FIGS. 4-6 illustrate a slip clutch assembly 110 according to another example. The slip clutch assembly 110 may be used, for example, within a motor vehicle or other structure. In some examples, the slip clutch assembly 110 may be used to limit an amount of torque that is applied to a system component for a power actuator for a motor vehicle or other structure (e.g., for a power sliding door, a liftgate, a tail gate, or other vehicle component on a motor vehicle). The slip clutch assembly 110 may be positioned between a power actuator (not shown) and the system component to thereby limit the amount of torque applied to the system component from the power actuator.

With reference to FIGS. 4-6, the slip clutch assembly 110 generally includes an output member 114, an input member 118, and a magnetic member 122 coupled to the output member 114.

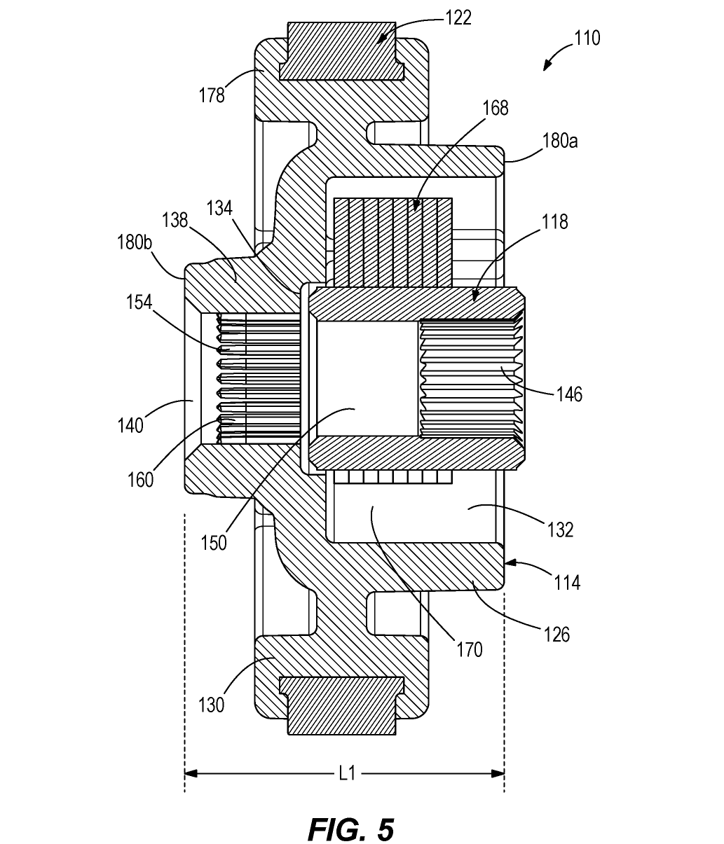

In the illustrated example, the output member 114 includes a first, interior housing portion 126 and a second, exterior housing portion 130. A cavity 132, which receives the input member 118, is defined within the interior housing portion 126. As illustrated in FIG. 5, the input member 118 may engage or otherwise be located proximate to a shoulder region 134 formed within the interior housing portion 126.

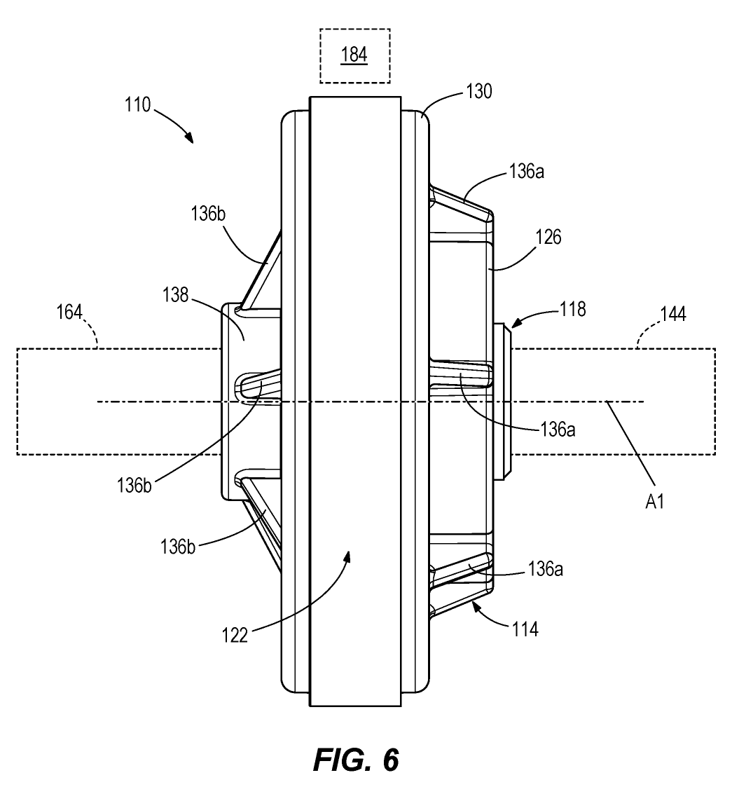

In the illustrated example, the exterior housing portion 130 is integrally formed (i.e., as a single monolithic piece) with the interior housing portion 126, and various connecting features are provided to further strengthen the structure of the output member 114. For example, and as seen in FIGS. 4 and 6, multiple tapered arms 136a, 136b are formed between the interior and exterior housing portions 126, 130. In some examples, and as seen in FIG. 4, a flange 137 is formed between the interior housing portion 126 and the exterior housing portion 130. Other examples may include various other numbers or arrangements of connecting features (e.g., tapered arms, flanges, etc.), or may not include such connecting features.

With reference to FIG. 5, the interior housing portion 126 may include an output region 138 formed as a cylindrical shaped protrusion. The output region 138 may extend axially beyond the exterior housing portion 130 in a forward direction relative to the input member 118. In the illustrated example, a bore 140 is defined through the output region 138. The bore 140 is in communication with the cavity 132 of the interior housing portion 126, such that the bore 140 is also in communication with at least a portion of the input member 118 when the slip clutch assembly 110 is assembled.

With reference to FIG. 6, the input member 118 may be sized and shaped to couple to an input shaft 144 (illustrated schematically in FIG. 6) that is driven by a power actuator. As illustrated in FIG. 5, the input member 118 may have a first spline configuration 146 formed therein and a recess 150 defined within the input member 118 opposite the first spline configuration 146. The first spline configuration 146 of the input member 118 is positioned at an input side of the slip clutch assembly 110 and configured to mate with a cooperating spline configuration (not shown) formed along the input shaft 144. The input member 118 and the input shaft 144 are thereby coupled for co-rotation such that input member 118 receives an input torque upon operation of the input shaft 144 by the power actuator.

When the input member 118 is disposed within the cavity 132 of the interior housing portion 126, the recess 150 of the input member 118 is positioned proximate the output region 138. As a result, the recess 150 of the input member 118 is in communication with the bore 140 of the output region 138, and the bore 140 of the output region 138 and the recess 150 of the input member 118 are coaxial. Other examples may include other sizes, shapes, and configurations of the input member 118 and interior housing portion 126, and may or may not include a recess 150, a bore 140, or other features as illustrated.

With continued reference to FIG. 5, in some examples the output region 138 includes a second spline configuration 154 formed along an interior surface 160 that defines the bore 140. An output shaft 164 (illustrated schematically in FIG. 6) may be sized and shaped to be received by the output region 138. The second spline configuration 154 may mate with a cooperating spline configuration (not shown) that is formed along the output shaft 164 to couple the output shaft 164 to the output member 114 for co-rotation. In some examples, and as seen in FIG. 5, a portion (e.g., unthreaded portion) of the output shaft 164 may also extend into the recess 150 of the input member 118 to rotate freely within the recess 150. Other examples may include other types and arrangements of spline configurations, or other structures (e.g., keyed structures) that facilitate a transfer of torque between the output member 114 and an output shaft.

Overall, the output shaft 164 may be coupled to the system component (e.g., motor vehicle component) so that the slip clutch assembly 110 transfers torque from the power actuator, through the input member 118, the output member 114, and to the output shaft 164 and the system component, until a threshold torque is reached, at which point a slip occurs. For example, and as seen in FIGS. 4 and 5, the slip clutch assembly 110 may include one or more slip rings 168. The slip ring 168 is disposed between the input member 118 and the interior housing portion 126 to operably couple the input member 118 to the output member 114. Frictional engagement is thereby respectively provided between the slip ring 168 and the input member 118.

In the illustrated example, and as seen in FIG. 4, the slip ring 168 includes a base region 170 that is nestled into (e.g., keyed into) and restrained by the interior housing portion 126 (e.g., within a recessed region defined by the interior housing portion 126 of the output member 114), and separate arms 172, 174 that extend from the base region 170 and wrap at least partially around the input member 118, frictionally engaging an outer surface of the input member 118. Once a predetermined threshold of torque is reached, the frictional engagement may loosen, allowing the input member 118 to slip relative to the arms 172 and 174, and thus slip relative to the connected output member 114. Other examples may include various other shapes, sizes, and configurations of slip rings or other clutch mechanisms (e.g., having one or more arms, structures, and/or surfaces that frictionally engage the input member 118, along with at least one region, structure, or surface, such as the base region 170, that engages the output member 114 to thereby transfer torque between the slip ring 168 and the output member 114).

During operation, as the slip ring 168 frictionally engages the input member 118, the input torque that is received by the input member 118 is transferred to the output member 114. The output member 114 co-rotates with the input shaft 144. Since the output shaft 164 is coupled to the output member 114 for co-rotation, the input shaft 144 and the output shaft 164 rotate together as one about a rotational axis A1 (FIG. 6). Once the input torque reaches or exceeds the torque threshold, the frictional engagement is overcome and the slip ring 168 facilitates slip of the input member 118 relative to the output member 114. Transfer of torque between the input member 118 and the output member 114 is interrupted, resulting in the input shaft 144 and the output shaft 164 no longer having a fixed rotational relationship. As such, the output shaft 164 is not operable to provide the output torque.

With reference to FIGS. 4 and 6, and as described above, the slip clutch assembly 110 additionally includes a magnetic member 122, which may include one or more different magnetic elements. The magnetic member 122 is coupled (e.g., integrally formed with, co-molded with, and/or otherwise attached to) the exterior housing portion 130 (e.g., along an exterior channel and/or peripheral portion of the exterior housing portion 130). In some examples, the magnetic member 122 is a magnet ring that circumferentially surrounds at least a portion of the interior housing portion 126. In some examples, and as seen in FIG. 5, the magnetic member 122 is a magnetic wheel molded to a periphery 178 of the exterior housing portion 130, and extends within a length L1 defined between a first interior housing end surface 180a formed on the interior housing portion 126 and a second interior housing end surface 180b formed on the output region 138.

Coupling the input member 118 to the output member 114 and molding or otherwise attaching the magnetic member 122 to the output member 114 may form an overall slip clutch assembly 110 as a singular and/or more compact component (as compared for example to the slip clutch assembly 10 of FIGS. 1-3). The size and weight of the slip clutch assembly 110 may thereby be reduced without sacrificing functionality of a slip clutch and detection of a true rotational position.

A sensor 184 (illustrated schematically in FIG. 6), similar to the sensor 62 of FIGS. 1-3, may also be positioned proximate the exterior housing portion 130 and spaced for example a distance from the magnetic member 122. The magnetic member 122 may be detected by the sensor 184, such that a rotational position of the output member 114 is determined. As the magnetic member 122 rotates and the magnetic field polarity changes, the sensor 184 may count a pulse. The sensor 184 may communicate how much the slip clutch assembly 110 has rotated with an electronic control unit (not shown) to help determine when slip has occurred between the input member 118 and the output member 114. Due to the positioning of the magnetic member 122 and the proximity of the sensor 184 to the magnetic member 122, the sensor 184 may be located between an output of the slip clutch assembly 110 (e.g., at the output region 138) and a location of slip between the input member 118 and the output member 114.

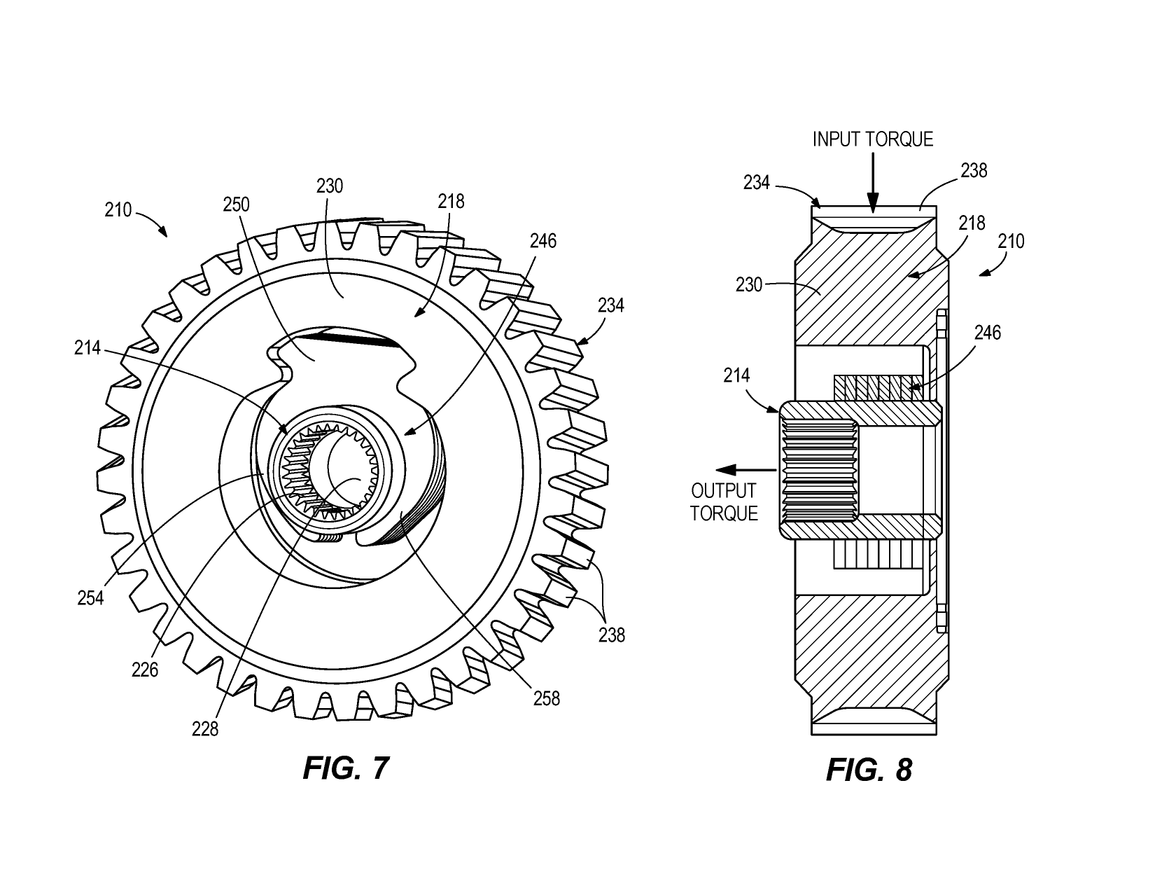

FIGS. 7 and 8 illustrate a slip clutch assembly 210 according to yet another example. The slip clutch assembly 210 may be used, for example, within a motor vehicle or other structure. In some examples, the slip clutch assembly 210 may be used to limit an amount of torque that is applied to a system component for a power actuator for a motor vehicle or other structure (e.g., for a power sliding door, a liftgate, a tail gate, or other vehicle component on a motor vehicle). The slip clutch assembly 210 may be positioned between a power actuator (not shown) and the system component to thereby limit the amount of torque applied to the system component from the power actuator.

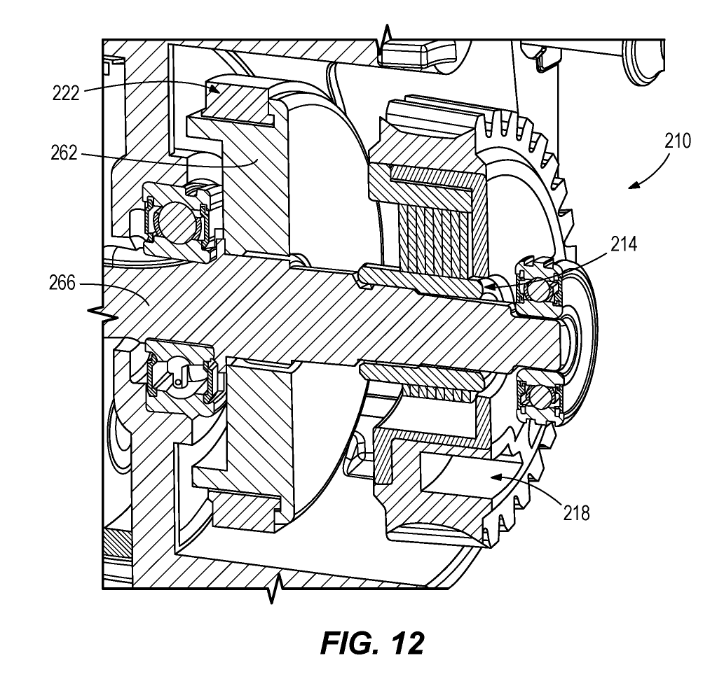

With reference to FIGS. 7 and 8, the slip clutch assembly 210 generally includes an output member 214 and an input member 218. As described further below, the slip clutch assembly 210 may also include a magnetic member 222 (FIG. 12).

In the illustrated example, and with continued reference to FIGS. 7 and 8, the output member 214 includes a spline configuration 226 formed along an interior surface that defines a bore 228. An output shaft (not shown) having a corresponding spline configuration may be sized and shaped to be coupled to the spline configuration 226, such that rotation of the output member 214 rotates the output shaft (or other structure) to deliver an output torque (FIG. 8). Other examples may include other types and arrangements of spline configurations, or other structures (e.g., keyed structures) that facilitate a transfer of torque between the output member 214 and an output shaft.

With continued reference to FIGS. 7 and 8, in the illustrated example the input member 218 includes a main housing 230, and an outer gear ring 234 coupled to (e.g., integrally formed as a single piece with or otherwise coupled to) the main housing 230. The outer gear ring 234 includes a plurality of gear teeth 238 projecting radially outwardly, that are sized and shaped to engage another input structure (e.g., gear, etc.) and/or a power actuator to deliver an input torque (FIG. 8) to the input member 218.

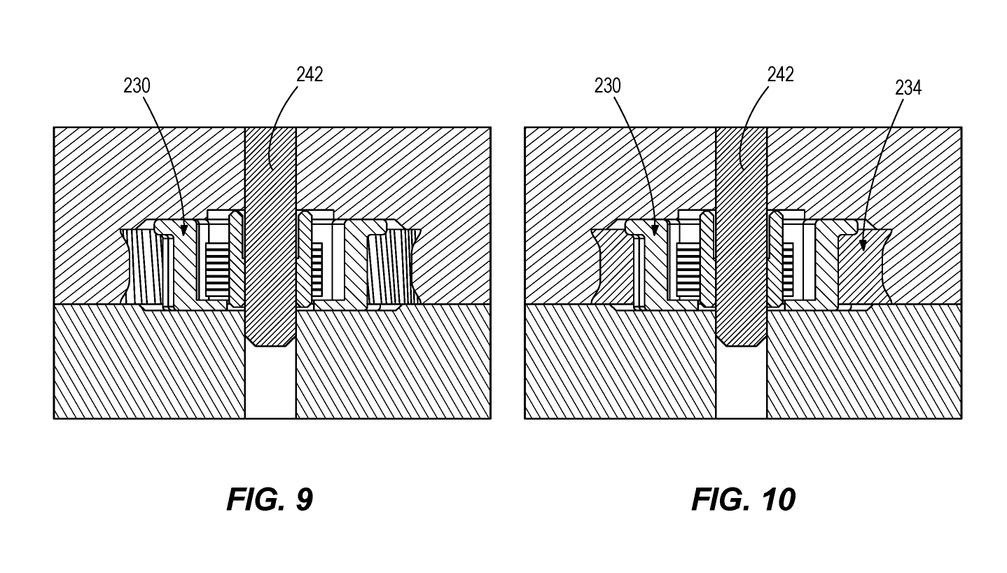

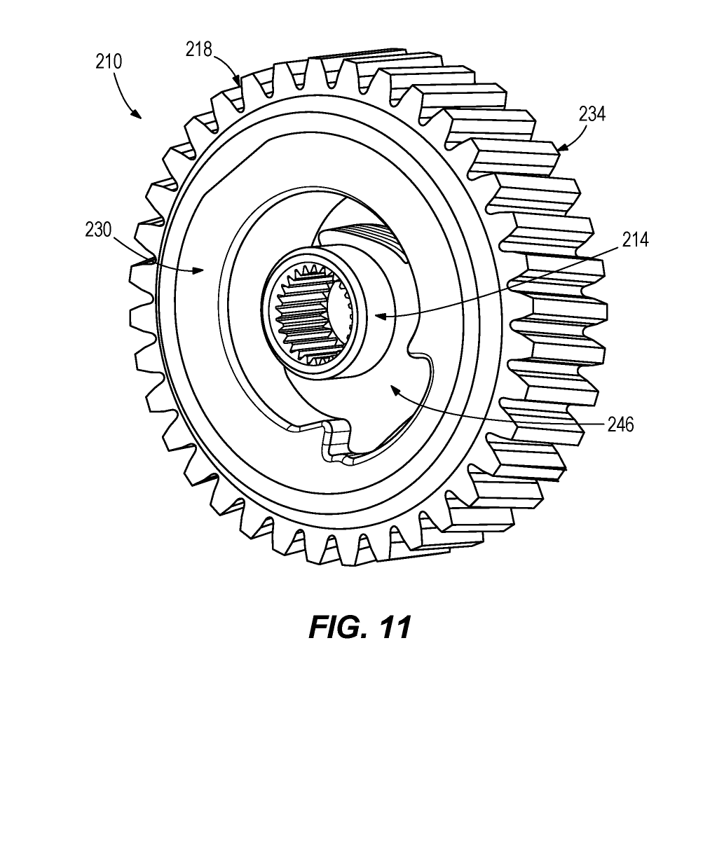

With reference to FIGS. 9-11, in some examples the outer gear ring 234 is formed via a molding process onto the main housing 230. For example, the main housing 230 may be coupled to a molding tool 242 (FIG. 9), and the outer gear ring 234 may then be formed / molded directly onto the main housing 230 (FIGS. 10 and 11).

With reference to FIG. 7, the slip clutch assembly 210 may further include a slip ring 246. The slip ring 246 may include a base region 250 that is nestled into (e.g., keyed into) and restrained by the main housing 230 of the input member 218 (e.g., within a recessed region), and separate arms 254, 258 that extend from the base region 250 and wrap at least partially around the output member 214, frictionally engaging an outer surface of the output member 214. Once a predetermined threshold of torque is reached, the frictional engagement may loosen, allowing the output member 214 to slip relative to the arms 254 and 258, and thus slip relative to the connected input member 218. Other examples may include various other shapes, sizes, and configurations of slip rings or other clutch mechanisms (e.g., having one or more arms, structures, and/or surfaces that frictionally engage the output member 214, along with at least one region, structure, or surface, such as the base region 250, that engages the input member 218 to thereby transfer torque between the slip ring 246 and the input member 218).

With reference to FIG. 12, and as described above, in some examples the slip clutch assembly 210 includes a magnetic member 222. The magnetic member 222 may be coupled for example to a separate magnet wheel 262, and may be detectable by a sensor. An output shaft 266 may extend through the output member 214 and the magnet wheel 262, such that rotation of the output member 214 also rotates the magnetic member 222.

With reference to FIGS. 4-6, in some examples the slip clutch assembly 110 may integrate a clutch and a magnet. With reference to FIGS. 7-12, in some examples the slip clutch assembly 210 may integrate a clutch and a gear. Both versions may allow for different packaging configurations, and for example smaller drive units.

Some of the examples may be further described by reference to the following numbered clauses:
1. A slip clutch assembly for use with a system component for a power actuator, the slip clutch assembly comprising:
   an input member configured to be rotationally driven by input torque from an input shaft;
   an output member configured to be rotationally driven by the input member until a threshold torque is reached; and
   a magnetic member coupled to the output member.
2. The slip clutch assembly of clause 1, wherein the magnetic member is a magnetic ring extending circumferentially about the output member.
3. The slip clutch assembly of clause 1 or clause 2, wherein at least a portion of the input member is disposed within the output member.
4. The slip clutch assembly of any of the preceding clauses, wherein the output member includes an interior housing portion having a cavity defined therein to receive a portion of the input member, and an exterior housing portion integrally formed with the interior housing portion, wherein the magnetic member is coupled to the exterior housing portion.
5. The slip clutch assembly of any of the preceding clauses, further comprising a sensor located proximate the output member, wherein the magnetic member is configured to be detected by the sensor to determine a rotational position of the output member.
6. The slip clutch assembly of any of the preceding clauses, further comprising a slip ring that operably couples the input member to the output member for co-rotation, the slip ring configured to facilitate slip of the input member relative to the output member upon the input torque reaching the threshold torque.
7. The slip clutch assembly of any of the preceding clauses, wherein the input member includes a first spline configuration formed therein and a recess defined therein.
8. The slip clutch assembly of clause 7, wherein the recess is sized and shaped to receive a portion of an output shaft.
9. The slip clutch assembly of clause 8, wherein the output member includes an interior housing portion and an exterior housing portion, wherein the output member further includes an output region that is a protrusion extending axially from the interior housing portion, wherein the protrusion includes a bore extending therethrough configured to receive the output shaft, and wherein the protrusion extends axially beyond the exterior housing portion.
10. The slip clutch assembly of clause 9, wherein the bore of the protrusion and the recess of the input member are coaxial.
11. The slip clutch assembly of clause 10, wherein the protrusion has a second spline configuration formed therein and operable to mate with the output shaft to provide output torque to the output shaft.
12. A slip clutch assembly for use with a system component for a power actuator, the slip clutch assembly comprising:
   an output member including an interior housing portion having a cavity defined therein and an exterior housing portion integrally formed with the interior housing portion;
   an input member disposed within the cavity of the interior housing portion and operably coupled to the output member for co-rotation, the input member configured to receive an input torque from an input shaft driven by a power actuator;
   an output region integrally formed with the interior housing portion, the output region configured to provide an output torque to an output shaft operably coupled to the system component; and
   a magnetic member integrated with the exterior housing portion, the magnetic member configured to be detected by a sensor proximate the output member to determine a rotational position of the output member.
13. The slip clutch assembly of clause 12, further comprising a slip ring that operably couples the input member to the output member for co-rotation, the slip ring configured to facilitate slip of the input member relative to the output member upon the input torque reaching a torque threshold to interrupt torque transfer between the output member and the input member.
14. The slip clutch assembly of clause 13, wherein the slip ring is one of a plurality of slip rings coupled to the input member.
15. The slip clutch assembly of any of clauses 12-14, wherein the input member has a first spline configuration formed therein and the output member has a second spline configuration formed therein.
16. The slip clutch assembly of any of clauses 12-15, wherein the input member and the output member are coaxial.
17. A slip clutch assembly for use with a system component for a power actuator, the slip clutch assembly comprising:
   an output member including an interior housing portion having a cavity defined therein and an exterior housing portion integrally formed with the interior housing portion, an input member disposed within the cavity of the interior housing portion and operably coupled to the output member for co-rotation, the input member configured to receive an input torque from an input shaft driven by a power actuator;
   a sensor disposed proximate the output member; and
   a magnetic wheel coupled to the exterior housing portion, the magnetic wheel configured to be detected by the sensor to determine a rotational position of the output member;
   wherein the sensor is located between an output of the slip clutch assembly and a location of slip between the output member and the input member.
18. The slip clutch assembly of clause 17, further comprising a slip ring that operably couples the input member to the output member for co-rotation, the slip ring configured to facilitate slip of the input member relative to the output member upon the input torque reaching a torque threshold to interrupt torque transfer between the output member and the input member.
19. The slip clutch assembly of clause 17 or clause 18, wherein the output member includes an output region that extends axially beyond the exterior housing portion.
20. The slip clutch assembly of clause 19, wherein the output region includes a spline configuration to receive an output shaft.
21. A slip clutch assembly for use with a system component for a power actuator, the slip clutch assembly comprising:
   an input member configured to be rotationally driven by input torque, wherein the input member includes a main housing and an outer gear ring coupled to the main housing;
   an output member configured to be rotationally driven by the input member until a threshold torque is reached; and
   a separate magnet wheel configured to be rotationally driven by the output member.

Although the disclosure has been described in detail referring to certain preferred embodiments, variations and modifications exist within the scope and spirit of one or more independent aspects of the disclosure as described.

What is claimed is:

1. A slip clutch assembly for use with a system component for a power actuator, the slip clutch assembly comprising:
an input member configured to be rotationally driven by input torque from an input shaft;
an output member configured to be rotationally driven by the input member until a threshold torque is reached; and
a magnetic member coupled to the output member.

2. The slip clutch assembly of claim 1, wherein the magnetic member is a magnetic ring extending circumferentially about the output member.

3. The slip clutch assembly of claim 1, wherein at least a portion of the input member is disposed within the output member.

4. The slip clutch assembly of claim 1, wherein the output member includes an interior housing portion having a cavity defined therein to receive a portion of the input member, and an exterior housing portion integrally formed with the interior housing portion, wherein the magnetic member is coupled to the exterior housing portion.

5. The slip clutch assembly of claim 1, further comprising a sensor located proximate the output member, wherein the magnetic member is configured to be detected by the sensor to determine a rotational position of the output member.

6. The slip clutch assembly of claim 1, further comprising a slip ring that operably couples the input member to the output member for co-rotation, the slip ring configured to facilitate slip of the input member relative to the output member upon the input torque reaching the threshold torque.

7. The slip clutch assembly of claim 1, wherein the input member includes a first spline configuration formed therein and a recess defined therein.

8. The slip clutch assembly of claim 7, wherein the recess is sized and shaped to receive a portion of an output shaft.

9. The slip clutch assembly of claim 8, wherein the output member includes an interior housing portion and an exterior housing portion, wherein the output member further includes an output region that is a protrusion extending axially from the interior housing portion, wherein the protrusion includes a bore extending therethrough configured to receive the output shaft, and wherein the protrusion extends axially beyond the exterior housing portion.

10. The slip clutch assembly of claim 9, wherein the bore of the protrusion and the recess of the input member are coaxial.

11. The slip clutch assembly of claim 10, wherein the protrusion has a second spline configuration formed therein and operable to mate with the output shaft to provide output torque to the output shaft.

12. A slip clutch assembly for use with a system component for a power actuator, the slip clutch assembly comprising:
an output member including an interior housing portion having a cavity defined therein and an exterior housing portion integrally formed with the interior housing portion;
an input member disposed within the cavity of the interior housing portion and operably coupled to the output member for co-rotation, the input member configured to receive an input torque from an input shaft driven by a power actuator;
an output region integrally formed with the interior housing portion, the output region configured to provide an output torque to an output shaft operably coupled to the system component; and
a magnetic member integrated with the exterior housing portion, the magnetic member configured to be detected by a sensor proximate the output member to determine a rotational position of the output member.

13. The slip clutch assembly of claim 12, further comprising a slip ring that operably couples the input member to the output member for co-rotation, the slip ring configured to facilitate slip of the input member relative to the output member upon the input torque reaching a torque threshold to interrupt torque transfer between the output member and the input member.

14. The slip clutch assembly of claim 13, wherein the slip ring is one of a plurality of slip rings coupled to the input member.

15. The slip clutch assembly of claim 12, wherein the input member has a first spline configuration formed therein and the output member has a second spline configuration formed therein.

16. The slip clutch assembly of claim 12, wherein the input member and the output member are coaxial.

17. A slip clutch assembly for use with a system component for a power actuator, the slip clutch assembly comprising:
an output member including an interior housing portion having a cavity defined therein and an exterior housing portion integrally formed with the interior housing portion,
an input member disposed within the cavity of the interior housing portion and operably coupled to the output member for co-rotation, the input member configured to receive an input torque from an input shaft driven by a power actuator;
a sensor disposed proximate the output member; and
a magnetic wheel coupled to the exterior housing portion, the magnetic wheel configured to be detected by the sensor to determine a rotational position of the output member;
wherein the sensor is located between an output of the slip clutch assembly and a location of slip between the output member and the input member.

18. The slip clutch assembly of claim 17, further comprising a slip ring that operably couples the input member to the output member for co-rotation, the slip ring configured to facilitate slip of the input member relative to the output member upon the input torque reaching a torque threshold to interrupt torque transfer between the output member and the input member.

19. The slip clutch assembly of claim 17, wherein the output member includes an output region that extends axially beyond the exterior housing portion, and wherein the output region includes a spline configuration to receive an output shaft.

20. A slip clutch assembly for use with a system component for a power actuator, the slip clutch assembly comprising:
an input member configured to be rotationally driven by input torque, wherein the input member includes a main housing and an outer gear ring coupled to the main housing;
an output member configured to be rotationally driven by the input member until a threshold torque is reached; and
a separate magnet wheel configured to be rotationally driven by the output member.
